(19) United States
(12) Patent Application Publication
(10) Pub. No.: US 2006/0239012 A1
(43) Pub. Date: Oct. 26, 2006

(54) Knockdown hardback lampshade with knockdown bottom spider

(75) Inventor: Chou Shih Bin, Taipei (TW)

Correspondence Address: ZITO TLP, 26005 RIDGE ROAD, SUITE 203, DAMASCUS, MD, 20872, US

(73) Assignee: Canel Lighting Co. Ltd.

(21) Appl. No.: 11/328,303

(22) Filed: Jan. 9, 2006

Related U.S. Application Data
(63) Continuation-in-part of application No. 11/146,634, filed on Jun. 7, 2005.
Application No. 11/146,634 is a continuation-in-part of application No. 11/111,377, filed on Apr. 21, 2005.

(51) Int. Cl. F21V 1/06

(52) U.S. Cl. 362/352; 362/450

(57) ABSTRACT

A lampshade having an upper ring, a lower ring, a mounting spider and a cover. One or both rings are segmented with releasable end connections. The legs and hub of the mounting spider are releasably joined, at least in part, with the legs attached to one of the rings, creating composite spider/ring elements. The shade is self-supporting when assembled, but its cover, rings and mounting spider may be collapsed to reduce volume when the shade is disassembled for packaging. To assemble the shade, the rings are placed into upper and lower edges of the cover and held in place by ring holders attached along the insides of the edges. A positioning nub protruding from each ring fits into a corresponding socket ring holder on each edge. The rings are press-fit between jaws of a plurality of clip ring holders. Tension in the cover holds the rings in place.

### RELATED APPLICATIONS

This application is a continuation-in-part of U.S. application Ser. No. 11/146,634 filed Jun. 7, 2005, now pending, which is a continuation in part of Application Ser. No. 11/111,377 filed Apr. 21, 2005, now pending. This application is also related to U.S. applications Ser. No. 11/154,300 filed Jun. 16, 2005, now pending; Ser. No. 10/997,744 filed Nov. 24, 2004, now pending; and No. 10/615,496, filed Jul. 8, 2003, now pending.

### FIELD OF THE INVENTION

The present invention relates to lampshade frames which are covered with a flexible material and can be collapsed to occupy less space during shipping and storage. More specifically, the present invention is a collapsible lampshade with a cover, removable upper and lower segmented rings, and a mounting spider, with a central mounting hub and detachable legs which are attached to the lower segmented ring, for positioning the lampshade on a lamp base.

### BACKGROUND OF THE INVENTION

A significant part of the sales price of a table lamp arises from the cost of transporting the lamp from the manufacturing plant to the retail sales store or to the purchaser and the cost for inventory space, shelf space and storage space. Because the bulky shape of the shade comprises a substantial portion of the lamp's total packaging volume, the assembled shade often disproportionately affects the shipping, display and storage cost and ultimately the sales price of the lamp. Therefore, it is desirable to create lampshades which may be manufactured and shipped in a knockdown configuration to reduce the shipping volume.

Prior art contains examples of collapsible shades, which depend on the stiffness of a removable frame to hold the shape of the shade after assembly. Prior art frames contain support rings, radial struts and vertical struts. The frame contributes a significant cost to the overall shade and in certain embodiments, it can be quite difficult to assemble.

Prior art also contains examples of knockdown designs of lampshades which are self-supporting, able to stand on their own without the need for intermediate supports. However, when the use of a mounting spider is required to hold the lampshade on a stand, the configuration of the spider again consumes valuable space during packaging and shipping. This is particularly true for a conically shaped spider support. It would therefore be beneficial to find a way to further reduce the shipping volume of these types of shades.

### SUMMARY OF THE INVENTION

A collapsible lampshade with a disconnectable mounting spider is disclosed having an upper ring and a lower ring, and a flexible cover, such as cloth, fabric or paper removably attached to the upper and lower rings. The cover is made from a thin sheet of material, generally flexible, but relatively stiff when formed into a taught cylindrical or conical shape. The upper and lower rings comprise circular-shaped bands, which fit snugly against respective upper and lower edges of the shade. With the rings installed, the upper and lower edges of the cover are stretched taught and the cover stiffens into its assembled lampshade shape. The rings are removed from the shade to allow the shade to be collapsed.

A mounting spider assembly spans either the upper or lower ring to facilitate mounting the lampshade onto a variety of lamps. The mounting spider comprises a plurality of legs and a mounting hub, and is manufactured as either a planar or conical-shaped structure. In the preferred embodiment, the legs of the mounting spider are permanently attached to the lower ring of the lampshade, but the attachment of the legs to the mounting hub is made via at least one releasable connection.

The rings of the lampshade may be segmented, allowing the rings to be disassembled and rearranged in a configuration for shipping which takes less space than would be required for the assembled ring. The ring segments may be releasably connected to each other via a plastic sleeve fit over mating ends of matching segments. Either or both rings may be segmented depending on their size relative to other components.

The preferred embodiment comprises the mounting spider attached to the (segmented) lower ring. When the ring is separated for packaging, the spider is also taken apart. The spider's legs, which are attached at their outer ends to a single ring segment, may all be disconnected from the central hub. Alternatively, depending on the configuration of the spider, it may not be necessary to disconnect all legs from the hub. For example, if the spider has a relatively flat conical shape, one or more of the legs may be permanently connected to the hub to aid in shade assembly. The separation options described above result in a set of composite leg/spider elements which may be arranged for packaging so as to reduce their overall volume as compared to that of the composite ring/spider element in its fully assembled form.

The lampshade includes a set of ring holders to fix and hold the rings in place when the lampshade is assembled for use. These comprise socket-type and clip-type ring holders located at the top and bottom inside edges of the lampshade. For the socket-type ring holders, a positioning nub located within planar indentations formed into both the upper and lower rings fits snugly into the hole of the socket. The engagement of the positioning nub within the socket holds that portion of the ring in place. For the clip-type holder, a pair of jaws are mounted along the inside edges of the cover. The bands of the upper or lower rings are pressed between the jaws of the clips to fix the rings in position. Tension is developed in the cover as a result of the installation of the rings. This tension develops the shape of the cover and holds both rings in place.

### BRIEF DESCRIPTION OF THE DRAWINGS

Exemplary embodiments of the invention are discussed hereinafter in reference to the drawings, in which:

FIG. 1 an illustration of the preferred embodiment of the collapsible lampshade of the present invention in its fully-assembled configuration.

FIG. 2 is an illustration of the cover of the lampshade which has been reduced in size by folding roughly in half after the removal of its upper and lower rings.

FIG. 3 is an illustration of the preferred embodiment of the lampshade showing the general location of socket and clip-type holders against the upper and lower inside surfaces of the cover.

FIG. 4 is an illustration of the upper ring of the preferred embodiment of the invention.

FIG. 5 is an illustration of the lower ring of the preferred embodiment of the invention, including the mounting spider which is attached to the ring at the outer end of the spider's legs.

FIG. 6 is an illustration of a type of releasable connection for the inner end of a mounting spider leg and the mounting hub.

FIG. 7 is an exploded view of the lower ring and mounting spider of the preferred embodiment of the invention, depicting two composite lower ring/mounting spider elements.

FIG. 8 is an illustration of the socket-type ring holders.

FIG. 9 is an illustration of the clip-type ring holders.

### DETAILED DESCRIPTION OF PREFERRED EXEMPLARY EMBODIMENTS

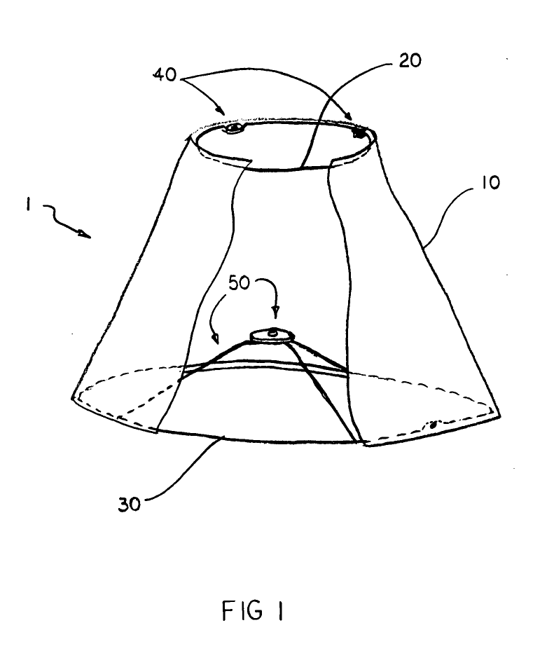

In a preferred embodiment, as shown in FIG. 1, the collapsible lampshade 1 of the present invention comprises a cover 10, an upper ring 20, a lower ring 30, a set of ring holders 40 and a mounting spider 50. As shown in FIG. 1, the cover comprises a sheet of material fashioned into the shape of a lampshade. In the illustrated embodiment, the shape of the lampshade is conical, but other shapes may be utilized as desired.

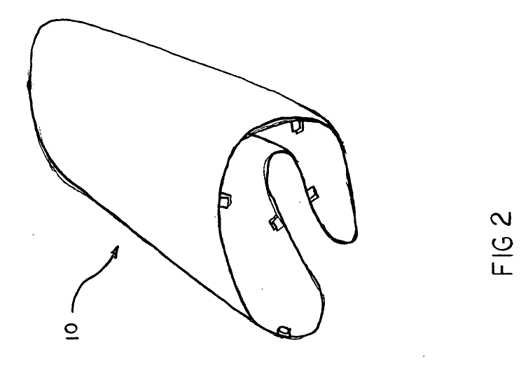

The cover 10 is made from a flexi-stiff material, such as stiff paper, thin plastic or stiffened cloth. The key properties of the flexi-stiff material are 1) that when the cover is fully expanded and incorporated into the assembled lampshade, the material provides sufficient rigidity to permit the shade to be self-supporting, and 2) that when the cover is not incorporated into the lampshade assembly, it may be collapsed (rolled, folded, flattened, etc.), an example of which is illustrated in FIG. 2, so as to reduce its volume. In a collapsed configuration, the cover may be packaged, shipped and stored utilizing much less space than in its fully expanded configuration.

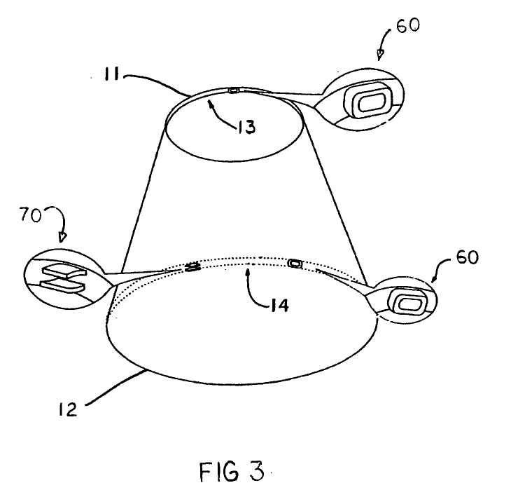

As illustrated in FIG. 3, the cover further comprises an upper and lower edge 11, 12, each edge defined by the opening at opposite ends of the cover. Each edge has an inside surface, being upper and lower inside surfaces 13, 14, which face toward the interior of the cover. The interior area of the cover is generally defined as the area inside the of the cover periphery extending between its upper edge and the lower edge.

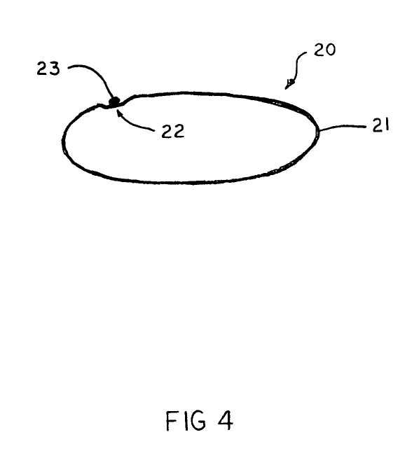

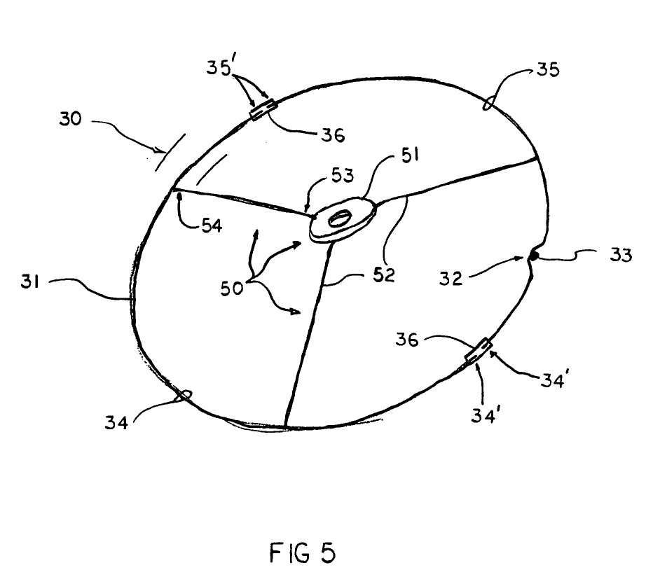

FIGS. 4 and 5 illustrate the upper and lower rings 20, 30. The upper and lower rings are both made from a circular band 21, 31 of metal, plastic or any other solid material. The band will preferably be round in cross-section, having a diameter large enough to generally hold its circular shape under the influence of moderate outside force. The rings will each be locally deformed by generally planar indentations 22, 32 at a single point on their circumferences. A positioning nub 23, 33 is rigidly attached to the band within the depression of the indentation. The nubs comprise a ball, knob, peg or any other similar projection jutting from the surface of the band.

The lower ring will be divided into at least two lower ring segments 34, 35. The segments are joined at mating ends 34′, 35′using a releasable connection. This connection may comprise a plastic tube 36 slid tightly over the mating ends of the joint or it may comprise a clevis and pin arrangement or any other connection type which allows the joint to either separate or fold together in hinge fashion. The purpose of the releasable connection is to permit the lower ring to be disassembled whereupon it may be arranged so as to reduce the volume required for its packing, shipping and storage. The planar indentation and positioning nub as described above will be located on one of the lower ring segments 35. As is the case for the preferred embodiment, the segmentation of the lower ring pre-supposes that the diameter of the lower ring is of a size compared to the collapsed cover that there would be a benefit realized in reducing its size for packing, shipping and storage. Should this not be the case, the lower ring could exist as a unitary element without departing from the concept of the invention.

The upper ring 20 of the preferred embodiment will be smaller than the lower ring 30 and will be of unitary construction existing as a single element. This presupposes the lampshade to be generally in the shape of a cone, with the top of the cone being of a smaller diameter than its bottom and that the upper ring will be of a suitable size to package and ship without the need for segmentation to reduce volume as compared to the collapsed cover. In cases where the upper ring is the same size or larger than the lower ring, or where it would otherwise be of advantage, the upper ring may be segmented in a manner similar to the lower ring without departing from the inventive scope.

The mounting spider 50 is a feature of the invention designed to allow the lampshade to be mounted on the top of a lampstand. The spider comprises a mounting hub 51 and a set of legs 52. Each leg has an inner end 53 and an outer end 54. The legs span the distance from the hub at their inner end to either the upper or lower ring at their outer end. In the preferred embodiment, the spider legs are attached to the lower ring. They extend upward from the lower ring toward the top of the cover in a conical arrangement, with the height of the spider cone being less than the height of the cover cone. The inner ends 53 of the legs connect to the hub 51 at the apex of the spider cone, thus positioning the hub on the vertical centerline of the cover.

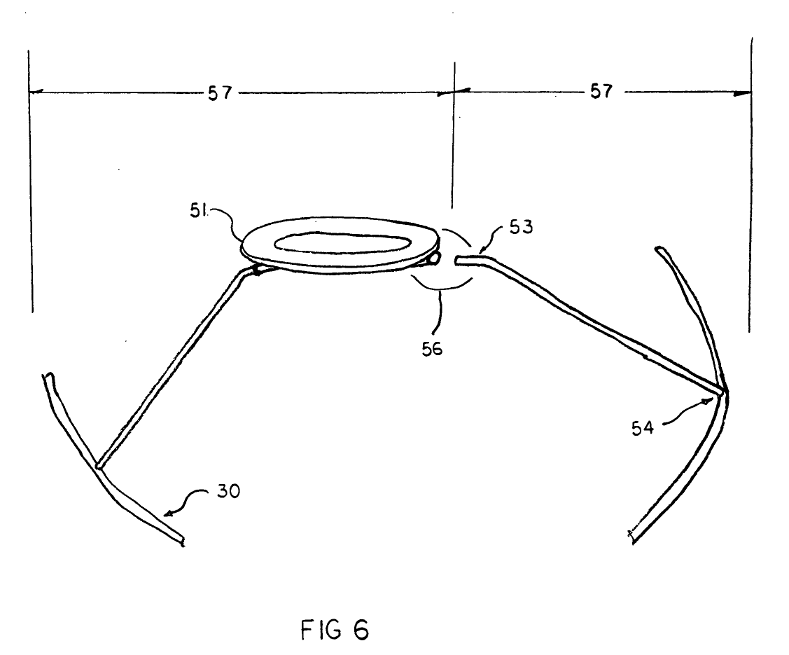

In the preferred embodiment, at least one of the inner ends of the legs of the spider connect to the hub in a releasable connection 56. As is depicted in FIG. 6, the releasable connection may comprise a shaft/sleeve joint, or it may comprise a snap fitting or any other style which may be easily connected and disconnected.

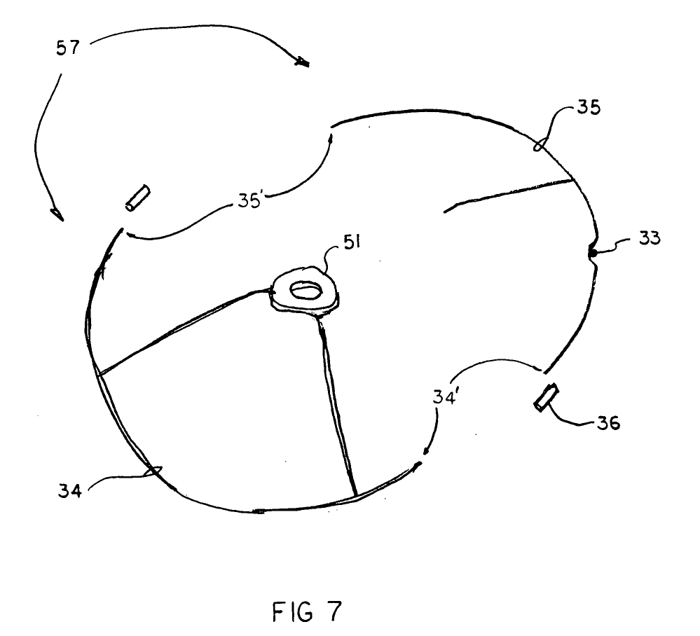

The purpose of the releasable connection is to allow the spider to be disassembled, at least in part, for the purposes of reducing its volume for packaging, shipment and storage. Since the outer end 54 of each leg is permanently connected to lower ring segments 34, 35, creating composite elements 57; as the lower ring is being assembled (or disassembled), the mounting spider 50 must also be assembled (or disassembled) with it. In order to break the lampshade 1 down for volume reduction, the inner end of any releasably connected legs is disconnected from the mounting hub and the lower ring is disassembled at its mating ends 34′, 35′. The result, as is illustrated in FIG. 7, is that the disassembled product now consists of two or more composite elements 57 each comprising permanently connected parts of both the lower ring and the mounting spider.

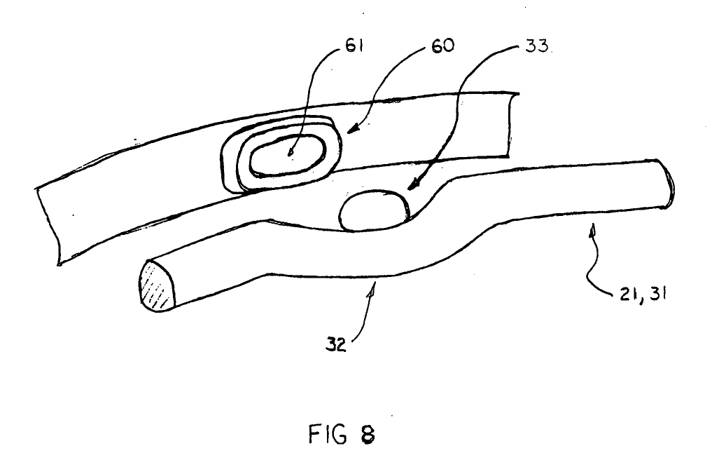

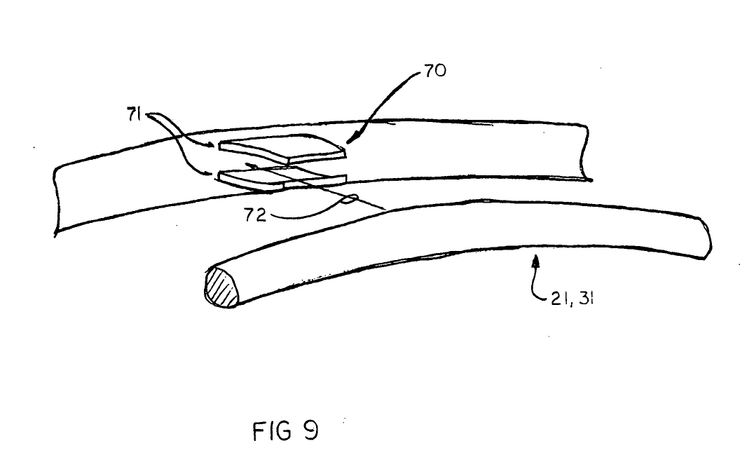

The ring holders are deployed along the inside surface of each of the upper and lower edges, respectively defining them as upper and lower ring holders. Both sets of ring holders come in two types. As shown in FIG. 8, the first type is a socket 60 comprising a socket hole 61 which is sized to accommodate a positioning nub 23, 33. There is one socket on each of the upper and lower inside surfaces (see FIG. 3). The second holder type is a clip 70, as shown in FIG. 9, comprising upper and lower jaws 71 which are generally spaced apart so as to accommodate the diameter of an upper and/or lower ring band. There are generally two or more clip-types holders on each (upper and lower) inside surface. Both the socket hole's opening and the opening between the clip's jaws are oriented toward the internal area of the cover.

The ring holders 60, 70 are used to hold the upper and lower rings 20, 30 against the upper and lower inside surfaces 13, 14 of the cover 10 during assembly of the lampshade 1. To utilize the socket-type holder, the positioning nub of a ring is positioned at the mouth of the socket hole and pushed into the hole, engaging the nub inside the socket. To utilize the clip-type holder, the band 21, 31 of a ring is pressed 72 into the opening between the jaws engaging the band inside the jaws.

To assemble a collapsed lampshade, first the composite lower ring segments with attached spider legs 57 are joined together. This involves joining the mating ends 34′, 35′ of the ring segments as well as connecting the inner ends 53 of the spider legs 52 to the mounting hub 51. Next, the positioning nub 23 of the upper ring 20 is engaged with the lone upper surface's socket ring holder 60. While maintaining the nub in the socket, the band 21 of the upper ring is then pressed into the clips 70 mounted on the upper inner surface. The diameter of the upper ring is designed to be just slightly less than the diameter of the upper edge. Thus when the upper ring is pressed into the upper clips, the upper edge of the cover becomes taught. The tightness forces the top of the shade into its intended shape (in this case, circular). The taught fit also holds the upper ring within the upper ring holders.

After the upper ring is installed, the lower ring 30 must be assembled. First, the two or more composite elements 57 of the lower ring and the mounting spider sections are connected to form a composite ring 30 and mounting spider 50 assembly. Next the lower ring is installed along the lower inner surface in a manner similar to that for the upper ring. If the mounting spider is conically shaped as shown in FIG. 1 for the preferred embodiment, the lower ring is installed with the mounting hub positioned up inside the interior area of the cover 10.

With the upper and lower rings installed in the cover, the properties of the flexi-stiff material acting within the confines of the cover, which is stretched taught by the upper and lower rings, creates a self-supporting lampshade which is now fully assembled and ready for use on a standard lampbase.

To disassemble the lampshade 1, first the lower ring is pressed out of the lower clip holders and then the lower positioning nub is pulled from the lower socket's socket hole. The upper ring is removed in a like manner. The lower ring/mounting spider is disassembled into its composite segment/leg elements 57 and the two or more composite elements are arranged into as small a packaging configuration as is possible. With the rings removed, the cover may now be collapsed, for example by folding it loosely in half (see FIG. 2). The composite ring/spider elements 57 and the upper ring 20 are added to the cover 10 and the reduced volume (i.e., the collapsed) lampshade 1 is ready for packaging, shipping and storage.

As has been alluded to above, it is possible that the lampshade may take on shapes other than that of a cone. For example, the shade could be shaped as an inverted cone, a cylinder or an hour glass. In all cases, the practice of reducing the volume of a disassembled lampshade, whatever its shape, by any combination of the techniques herein taught shall be considered an obvious extension thereof.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A collapsible lampshade, comprising:
an upper ring;
a lower ring comprising at least two releasably connectable lower ring segments;
a cover comprising a flexi-stiff material and having upper and lower edges wherein:
said edges have respective upper and lower inside surfaces; and
said cover comprises an interior area between said upper and lower edges;
a plurality of ring holders associated with said respective upper and lower inside surfaces creating respective upper and lower ring holders; and
a mounting spider comprising a mounting hub and a plurality of legs which releasably connect at an inner end with said mounding hub and which are permanently connected at an outer end to one of said lower ring segments, wherein;
to assemble said lampshade, said inner leg ends are releasably connected to said mounting hub to form said mounting spider and said lower ring segments are releasably connected to form said respective lower ring, and wherein;
said upper and lower rings are placed against said respective upper and lower inside surfaces of said cover, engaging said ring holders and developing tension in said upper and lower edges of said cover which holds said rings in place within said ring holders.

2. The collapsible lampshade of claim 1, wherein said cover, said rings, said ring holders and said mounting spider collectively create a self-supporting lampshade when said rings engage said ring holders along said inside surfaces.

3. The collapsible lampshade of claim 1, wherein said cover may be collapsed to a reduced volumetric size when said rings are not engaging said ring holders along said inside surfaces.

4. The collapsible lampshade of claim 1, wherein said releasable connections of said lower ring comprises a plastic tube slid over respective mating ends of respective lower ring segments.

5. The collapsible lampshade of claim 1, wherein said releasable connection of said inner end of said legs to said mounting hub comprises a shaft/sleeve style of joint.

6. The collapsible lampshade of claim 1, wherein said lower ring segments and said mounting hub and legs may be disconnected at their respective said releasable connections and arranged so as to reduce their collective volumetric size.

7. The collapsible lampshade of claim 1 wherein:
said legs of said mounting spider project away from said mounting hub in an upward conical arrangement with said mounting hub defining a vertex of said arrangement when said mounting spider is assembled; and
said mounting hub is positioned within said interior area of said cover when said lampshade is assembled.

8. The collapsible lampshade of claim 1 further comprising:
upper and lower rings further comprising a generally circular band, deformed with a planar indentation at one location on each band and having a diameter; and
a fixing nub permanently attached to each said band within said indentation; wherein;
said ring holders comprise one socket having a socket hole oriented toward said interior area of said cover and at least one clip having upper and lower jaws spaced apart at a distance of said diameter and oriented toward said interior area of said cover; and wherein;
said engagement of said upper and lower rings with said respective upper and lower ring holders comprises:
placing said fixing nubs into said respective socket holes; and
placing said bands in between said respective jaws at respective points of engagement of said bands and jaws as said upper and lower rings are placed against said respective upper and lower inside surfaces.
